(19) United States
(12) Patent Application Publication
(10) Pub. No.: US 2020/0134511 A1
(43) Pub. Date: Apr. 30, 2020

(54) SYSTEMS AND METHODS FOR IDENTIFYING DOCUMENTS WITH TOPIC VECTORS

(71) Applicants: Nhung Ho, Redwood City, CA (US); Meng Chen, Sunnyvale, CA (US); Heather Simpson, Sunnyvale, CA (US); Xiangling Meng, Mountain View, CA (US)

(72) Inventors: Nhung Ho, Redwood City, CA (US); Meng Chen, Sunnyvale, CA (US); Heather Simpson, Sunnyvale, CA (US); Xiangling Meng, Mountain View, CA (US)

(73) Assignee: Intuit Inc., Mountain View, CA (US)

(21) Appl. No.: 16/175,525

(22) Filed: Oct. 30, 2018

(51) Int. Cl. G06N 99/00; G06F 17/30

(52) U.S. Cl. CPC G06N 99/005; G06F 17/30014

(57) ABSTRACT

One or more embodiments are directed to identifying documents with topic vectors by training a machine learning model with a training documents generated from text collections, receiving, after generating a list of topic vectors for the plurality of text collections, an additional text collection, and generating an additional topic vector for the additional text collection without training the machine learning model on the additional text collection. One or more embodiments further include updating the list of topic vectors with additional topic vectors that includes the additional topic vector, receiving a first topic vector based on a first text collection generated in response to user interaction, and matching the first topic vector to the additional topic vector. One or more embodiments further include presenting a link corresponding to the additional text collection in response to matching the first topic vector to the additional topic vector.

### BACKGROUND

Machine learning uses complex models and algorithms that lend themselves to identifying articles for recommendations. The application of machine learning models uncovers insights through learning from historical relationships and trends in data.

Machine learning models that recommend articles can be hard to train with data sets that change over time and have a large number of documents. Classical methods, such as collaborative filtering and matrix factorization, are designed for a fixed set of training documents. A challenge is identifying articles without training a machine learning model on the articles to be identified.

### SUMMARY

In general, in one or more aspects, the disclosure relates to a method that involves training a machine learning model with training documents generated from text collections. After generating a list of topic vectors for the text collections, an additional text collection is received. The method further involves generating an additional topic vector for the additional text collection without training the machine learning model on the additional text collection, updating the list of topic vectors with additional topic vectors that includes the additional topic vector, receiving a first topic vector based on a first text collection generated in response to user interaction, and matching the first topic vector to the additional topic vector. The method further involves presenting a link corresponding to the additional text collection in response to matching the first topic vector to the additional topic vector.

In general, in one or more aspects, embodiments are related to a system that includes a memory coupled to a processor, and a machine learning service that executes on the processor and uses the memory. The machine learning service is configured for training a machine learning model with training documents generated from text collections, receiving, after generating a list of topic vectors for the plurality of text collections, an additional text collection, and generating an additional topic vector for the additional text collection without training the machine learning model on the additional text collection. The machine learning service is further configured for updating the list of topic vectors with additional topic vectors that includes the additional topic vector, receiving a first topic vector based on a first text collection generated in response to user interaction, and matching the first topic vector to the additional topic vector. The link corresponding to the additional text collection is presented in response to matching the first topic vector to the additional topic vector.

In general, in one or more aspects, embodiments are related to a non-transitory computer readable medium with computer readable program code for training a machine learning model with training documents generated from text collections, receiving, after generating a list of topic vectors for the text collections, an additional text collection, and generating an additional topic vector for the additional text collection without training the machine learning model on the additional text collection. The computer readable program code is further for updating the list of topic vectors with additional topic vectors that includes the additional topic vector, receiving a first topic vector based on a first text collection generated in response to user interaction, and matching the first topic vector to the additional topic vector. The computer readable program code is further for presenting a link corresponding to the additional text collection in response to matching the first topic vector to the additional topic vector.

Other aspects of the invention will be apparent from the following description and the appended claims.

### BRIEF DESCRIPTION OF DRAWINGS

FIG. 1A, FIG. 1B, and FIG. 1C show a system in accordance with one or more embodiments of the present disclosure.

FIG. 2 shows a method for topic vector generation and identification in accordance with one or more embodiments of the present disclosure.

FIG. 3A and FIG. 3B show an example of topic vector generation and identification in accordance with one or more embodiments of the present disclosure.

FIG. 4A and FIG. 4B show a computing system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments that are in accordance with the disclosure have documents that are used for training a machine learning model. A document is any collection of text that is used to train a machine learning model. Examples of a document include an article (e.g., blog posts, frequently asked questions, stories, manuals, essays, writings, etc.) and a search related sting. A single document may include multiple independent pieces of text (i.e., a text collection). For example, a single document may include an article, metadata about the article, clickstream and search stream information after which a user selected the article, and other information. A document may thus be referred to as a training document and is a type of text collection. After training the machine learning model on the training documents, the text collections used to train the machine learning model and additional text collections that were not used to train the machine learning model may be fed into the machine learning model to generate topic vectors. The distances between two topic vectors can then be used to identify the similarity between two text collections, even when the text collections were not used to train the machine learning model.

In general, embodiments that are in accordance with the disclosure train a machine learning model on a corpus of training documents that includes search strings and articles. The machine learning model can then be used to generate topic vectors for any text collection. The topic vectors can be used to identify which text collections are similar to each other. For example, when a topic vector of a text collection that is an article is similar to the topic vector of a text collection that is a search string, the article can be provided as a result for the search string. The machine learning model can be applied to any text collection, including text collections that were not included in the training documents used to train the machine learning model.

The machine learning model is periodically updated to be retrained with an updated set of training documents that can include text collections that were not previously used to train the machine learning model. Retraining the machine learning model improves the ability of the machine learning model to identify and match similar articles, search strings, and text collections.

Using the machine learning model, an article may be identified that is similar to the text collection gathered from user's interactions. The article may be a first text collection and the user's interactions may be a second text collection that is used as input to the machine learning model. Topic vectors generated from the user's interactions and article are identified as being similar. Thus, in response to user's interaction, a link to the article may be returned.

As an example of training and use, a user can search for “homedepot charge” using a website and does not click on any of the links presented in response to the search. The user then searches for “homedepot transaction” and clicks on a link for an article titled “missing transactions” (which was converted to lower case). The system can generate a training document for this user interaction in the form of a search related string that includes “homedepot charge homedepot transaction missing transactions”. This search related string includes both of the search phrases from the user and includes the article title. The search related string can be fed into the machine learning model to generate a topic vector without the machine learning model being trained on this search related string. A subsequent user can search for “homedepot charge” and the topic vector generated for “homedepot charge” can be matched to the topic vector generated for “homedepot charge homedepot transaction missing transactions”. The article titled “missing transactions” is identified and presented as a result to the subsequent user based on matching the topic vectors so that the subsequent user can access the article by performing fewer searches even though the machine learning model had not been trained on either of the search related strings.

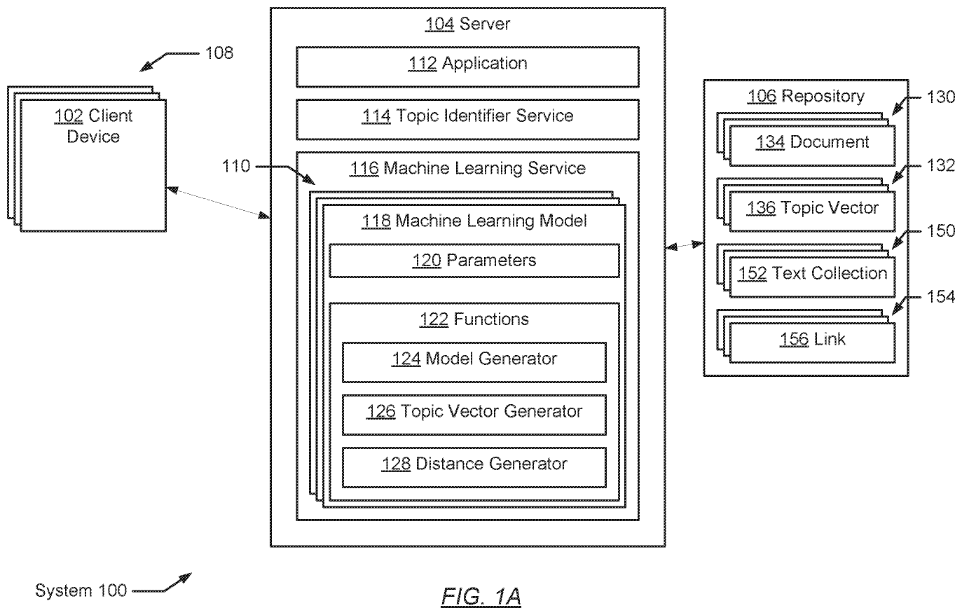

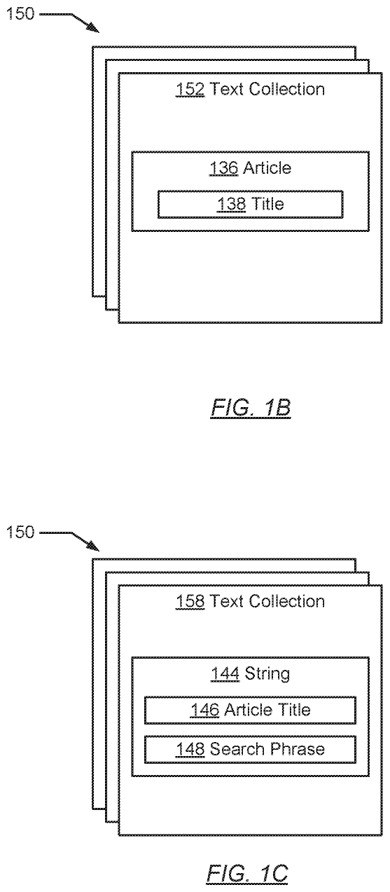

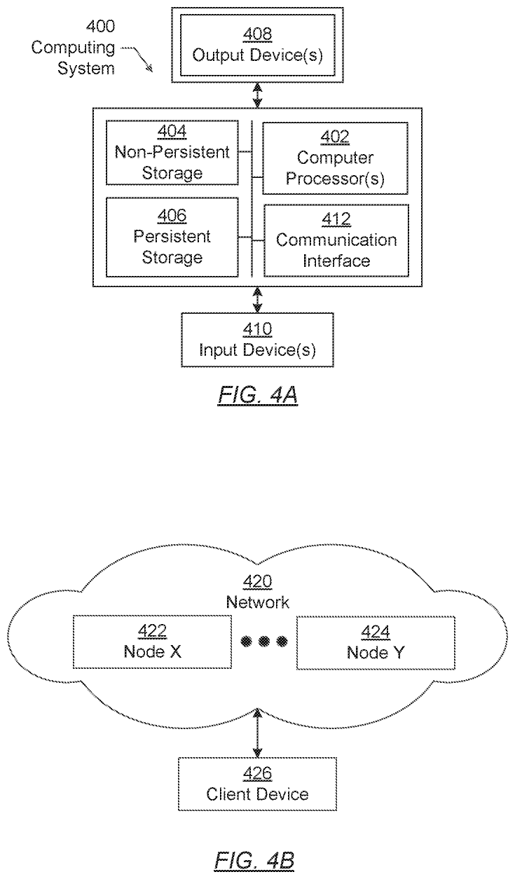

FIG. 1A, FIG. 1B, and FIG. 1C show diagrams of the system (100) in accordance with one or more embodiments of the invention. The various elements of the system (100) may correspond to the computing system shown in FIG. 4A and FIG. 4B. In particular, the type, hardware, and computer readable medium for the various components of the system (100) is presented in reference to FIG. 4A and FIG. 4B. In one or more embodiments, one or more of the elements shown in FIGS. 1A, 1B, and 1C may be omitted, repeated, combined, and/or altered as shown from FIGS. 1A, 1B, and 1C. Accordingly, the scope of the present disclosure should not be considered limited to the specific arrangements shown in FIGS. 1A, 1B, and 1C.

Referring to FIG. 1A the system (100) includes the client devices (108), the server (104), and the repository (106). The client devices (108) interact with the server (104), which interacts with the repository (106).

The client device (102) is one of the client devices (108), is an embodiment of the computing system (400) of FIG. 4A, and can be embodied as one of a smart phone, a tablet computer, a desktop computer, and a server computer running a client service. In one or more embodiments, the client device (102) includes a program, such as a web browser or other application, that accesses the application (112) on the server (104). In one or more embodiments, the application (112) includes a search service that can be accessed by the client device (102). The search service provides recommendations for text collections that can be provided to the user of the user device (102). For example, the search service may provide recommendations for text collections that include a user manual or frequently asked questions (FAQ) page that describes how to use the application (112). In one or more embodiments, a browser history generated by the interaction between the client device (102) and the application (112) is used to identify the recommended text collections by the search service of the application (112).

The server (104) is a set of one or more computing systems, programs, and virtual machines that operate to execute the application (112), the topic identifier service (114), and the machine learning service (116). The server (104) handles requests from the client devices (108) to interact with the application (112). The server (104) interacts with the repository (106) to store and maintain the documents (130), the topic vectors (132), the text collections (150), and the links (154), as described below.

The application (112) includes a set of software components and subsystems to interact with the client devices (102) and the repository (106). For example, the application (112) can be a website, web application, or network application through which data from the client device (102) is received and processed by the topic identifier service (114) and the machine learning service (116). In one or more embodiments, the application (112), the topic identifier service (114) and the machine learning service (116) are accessed through a representational state transfer web application programming interface (RESTful web API) utilizing hypertext transfer protocol (HTTP).

An example of the application (112) is a chatbot. Interaction between a user and the chatbot is by a sequence of messages that are passed to the chatbot using standard protocols. The messages can be email messages, short message service messages, and text entered into a website.

Another example of the application (112) is a website with a search service. Interaction between the user and the website can be recorded as a clickstream that includes all of the user interaction events generated by a user of the website. The user interaction events include clicking on links and buttons, entering text into text fields, scrolling within displayed pages, etc. In one or more embodiments, the clickstream includes each of the searches performed by the user within a threshold amount of time (e.g., 30 minutes) as well as each link and article title clicked on by the user in response to a search.

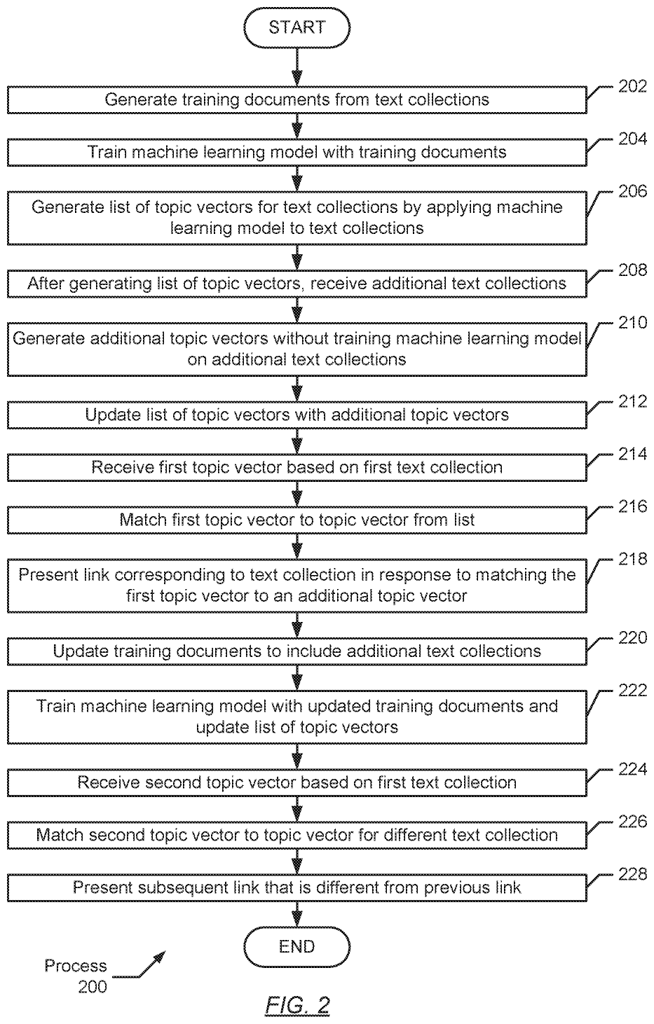

The topic identifier service (114) is a set of software components and subsystems executing on the server (104) to identify topic vectors, which are further described below. In one or more embodiments, the topic identifier service (114) identifies topic vectors based on interaction between the client device (102) and the application (112), which is further discussed below in Step (214) of FIG. 2.

The machine learning service (116) is a set of software components and subsystems executing on the server (104) that operates the machine learning models (110) to generate and process the topic vectors (132).

The machine learning models (110) are each a set of software components and subsystems executing on the server (104) that operate to analyze the documents (130), generate the topic vectors (132), and do comparisons against the topic vectors (132). In one or more embodiments, the machine learning models (110) can include models that are trained on different sets of the documents (130) in the repository (106). For example, an initial model can be trained on an initial set of documents, and a subsequent model can be trained on a subsequent set of documents that has been updated to add or remove one or more documents from the initial set of documents. Additionally, different machine learning models (110) can be trained on different types of documents. For example, one machine learning model can be trained on documents with search strings and another model can be trained on documents that include articles written by users. Each of the machine learning models (110) is trained using one or more algorithms that include Latent Dirichlet Allocation (LDA), latent semantic indexing (LSI), non-negative matrix factorization (NMF), word2vec, doc2vec, and sent2vec.

The machine learning model (118) is one of the machine learning models (110) and is trained on the documents (130). The machine learning model (118) includes the parameters (120), and exposes an application programming interface (API) that includes the functions (122). In one or more embodiments, the machine learning model (118) uses the LDA algorithm.

The parameters (120) are specific to the machine learning model (118) and includes the variables and constants generated for and used by the machine learning model (118). For the LDA algorithm, the parameters (120) can include a first matrix that relates documents to topics, a second matrix that relates words to topics, and the number of topics. In one or more embodiments, the number of topics is selected from the range of about 100 to about 500 and is selected to be about 250.

The functions (122) are exposed by the application programming interface of the machine learning model (118) and include functions for the model generator (124), the topic vector generator (126), and the distance generator (128). In one or more embodiments, functions (122) are class methods that are invoked by the machine learning model (118) or the machine learning service (116).

The model generator (124) is a function that trains and updates the parameters (120) of the machine learning model based on a corpus of the documents (130). Common words that do not help identify a topic, such as “a” and “the” can be removed from the document before training the parameters (120). When using the LDA algorithm, for each training document from the set of documents (130), the parameters (120) (e.g., the first and second matrices described above) are updated based on frequency of word co-occurrence encountered within the documents used for training.

The topic vector generator (126) is a function that generates a topic vector from a text collection. In one or more embodiments, a topic vector that is generated for a first text collection, which includes a search string, is used to map the first text collection to a second text collection. The second text collection, which includes an article, has a similar topic vector as measured by the distance between the topic vector of the first text collection and the topic vector of the second text collection. A search using the search string of the first text collection can return the article of the second text collection as a result based on the mapping between the first text collection and the second text collection.

Any words that were removed when generating the machine learning model (118) can similarly be removed from a text collection before generating the topic vector. In one or more embodiments, the LDA algorithm is used and the topic vector may be determined by calculating the most likely topic given the words in the text collection using a trained topic-word distribution matrix. If the text collection is part of the set of training documents, then the topic vector may be the row from the document topic matrix that corresponds to the training document.

The distance generator (128) is a function that determines the distance between two topic vectors. In one or more embodiments, the distance is determined by calculating the Euclidean distance between the two topic vectors. The Euclidean distance is calculated by taking the square root of the sum of the squares of the distances between each element in the topic vectors, which is a scalar value that is proportional to the distance between the two topic vectors.

Other algorithms can be used instead of or in addition to LDA. Each different algorithm generates a topic vector from a text collection in a different manner, such that the value and length of the topic vectors from different algorithms can be different from each other. The topic vectors generated from one algorithm are internally consistent so that the distance between two topic vectors generated from one algorithm can identify a similarity between the two text collections that were used to generate the two topic vectors.

Latent semantic indexing can be used which is an indexing and retrieval method using singular value decomposition (SVD) to identify patterns in the relationships between the terms and concepts contained in the corpus of documents (130). The parameters for models that use latent semantic indexing include a matrix U for left singular vectors and a matrix S for singular values. The matrix V for right singular values can be reconstructed using the corpus of documents (130) and the U and S matrices as needed. The parameters (120) can include one or more of the matrices U, S, and V.

Additionally, one or more of the word2vec, doc2vec, and sent2vec algorithms can be used and the parameters (120) would include a neural network that is trained by the model generator (124) and generates predictions that are used by the topic vector generator (126).

The repository (106) stores the documents (130), the topic vectors (132) the text collections (150), and the links (154). In one or more embodiments of the invention, the data repository (106) is any type of storage unit and/or device (e.g., a file system, database, collection of tables, or any other storage mechanism) for storing data. Further, the data repository (106) may include multiple different storage units and/or devices. The multiple different storage units and/or devices may or may not be of the same type or located at the same physical site.

The documents (130) include a set of training documents. The training documents are used to train the parameters (120) of the machine learning model (118).

Each of the topic vectors (132) is a vector of elements. In one or more embodiments, each element is a rational number from 0 to 1, the sum of all elements is equal to 1, and each of the topic vectors (132) has the same number of elements. In one or more embodiments when the LDA algorithm is used, each element is a probability that the document (134) used to generate the topic vector (136) is related to a topic that is identified by the element. A topic is associated with the meaning of one or more words, and there can be fewer topics than words. The number of topics corresponds to the length of the topic vectors and can be fixed by the system.

The document (134) is one of the documents (130). In one or more embodiments, the document (134) is a training document generated from the text collection (152), described below.

The topic vector (136) is one of the topic vectors (132). In one or more embodiments, the topic vector (136) was generated for the text collection (152) by topic vector generator (126) of the machine learning model (118).

The text collections (150) include the text collection (152). The text collection (152) is any collection of text stored as a string of characters, examples of which include articles, web pages, blog posts, frequently asked questions, stories, manuals, essays, writings, text messages, chatbot input messages, search queries, search related strings, etc. A text collection may be multiple separate pieces of text. Two examples of the text collections (150) are further described below with reference to FIG. 1B and FIG. 1C.

The links (154) include the link (156). The links (154) provide access to the text collections (150). In one or more embodiments, the link (156) is a hypertext link that includes a uniform resource identifier (URI) that identifies the text collection (152).

Referring to FIG. 1B, the text collections (150) include the text collection (152). The text collection (152) includes the article (136). In one or more embodiments, the article (136) includes the title (138) and is an electronic document, such as a web page or hypertext markup language (HTML) file, that can include text and media to discuss or describe one or more topics related to news, research results, academic analysis, debate, frequently asked questions, user guides, etc.

Referring to FIG. 1C, the text collections (150) include the text collection (158). The text collection (158) includes the string (144). The string (144) includes the article title (146) and the search phrase (148). In one or more embodiments, the string (144) is a sequence of characters using a character encoding, types of which include American Standard Code for Information Interchange (ASCII) and Unicode Transformation Format (UTF). In one or more embodiments, the article title (146) within the string (144) is the title (138) of the article (136) from the text collection (152) of FIG. 1B, which was selected (e.g., clicked on by a user) from a result generated in response to search phrase (148). In one or more embodiments, the search phrase (148) includes a group of words generated by a user for which a set of results was generated. For example, the string (144) can be a search related string that includes “homedepot charge homedepot transaction missing transactions”. The search queries “homedepot charge” and “homedepot transaction” are concatenated into the search phrase (148), which is concatenated with the title (146) “missing transactions” to form the string (144).

FIG. 2 shows a flowchart in accordance with one or more embodiments of the present disclosure. The flowchart of FIG. 2 depicts a process (200) for topic vector generation and identification. The process (200) can be implemented on one or more components of the system (100) of FIG. 1. In one or more embodiments, one or more of the steps shown in FIG. 2 may be omitted, repeated, combined, and/or performed in a different order than the order shown in FIG. 2. Accordingly, the scope of the present disclosure should not be considered limited to the specific arrangement of steps shown in FIG. 2.

In Step (202), training documents are generated from the text collections. In one or more embodiments, the machine learning service generates the training documents from the text collections. In one or more embodiments, the training documents include only articles, only strings with search phrases and titles, or both articles and strings with search phrases and titles. The generation process can involve regularizing the text in the text collections.

Text regularization is applied to each of the text collections that are selected for training the machine learning model. In one or more embodiments, the output of the text regularization is a set of regularized training documents that are used as the training documents for training the machine learning model. Text regularization involves operations including, among other things: (1) removing special characters (e.g., dashes); (2) removing stop words, e.g., articles like “the”, as well as stop words in a custom dictionary; (3) stemming (e.g., changing “cleaning” to “clean”); (4) lowering the case of characters; (5) removing short words (e.g., “of”); (6) creating bigrams (e.g., a term with two unigrams such as “goods” and “sold”); and (7) auto-correcting typos.

In Step (204), the machine learning model is trained with the training documents. In one or more embodiments, the machine learning model is trained by iterating through each document of the corpus of training documents and updating the parameters of the machine learning model based on the training documents. Training of the machine learning model can be triggered periodically (e.g., weekly, monthly, quarterly, etc.) and can be triggered when a threshold amount of additional text collections are added to the repository. The training process can involve applying the machine learning model algorithm to the text.

The algorithm for the machine learning model is applied to the training documents to generate a collection of topics. In one or more embodiments, the algorithm is the LDA algorithm. Here it will be appreciated that LDA is a generative statistical model for text clustering based on a “bag-of-words” assumption, namely, that within a document, words are exchangeable and therefore the order of words in a document may be disregarded. Further, according to this assumption, the documents within a corpus are exchangeable and therefore the order of documents within a corpus may be disregarded. Proceeding from this assumption, LDA uses various probability distributions (Poisson, Dirichlet, and/or multinomial) to extract sets (as opposed to vectors) of co-occurring words from a corpus of documents to form topics.

The LDA algorithm learns the topics based on the distribution of the features in an aggregated feature matrix. By way of an example, the LDA topic modeling algorithm calculates, for each topic, using the aggregated feature set, a set of posterior probabilities that each behavior group is included in the topic. Further processing may be performed to limit the number of topics and/or reduce the size of the matrix. For example, the further processing may be to remove topics that do not have a feature satisfying a minimum score threshold and/or to remove features that do not satisfy a minimum score threshold. By way of another example, the further processing may be used to limit the number of topics to a maximum number.

It will be appreciated that there are other algorithms that can extract groups of co-occurring words to form topics. For example, one might apply word2vec to the words in a corpus of documents to create a co-occurrence matrix for those words and then identify nearest neighbors using a similarity-distance measure such as cosine similarity.

In Step (206), topic vectors are generated for text collections. In one or more embodiments, the machine learning service generates a list of topic vectors by applying the machine learning model to the text collections in the repository. In one or more embodiments, the machine learning model is a topic modeling algorithm that is applied by the machine learning service to the text collections. The topic modeling algorithm relates topics to objects, such as the text collections. Specifically, for each object, the topic modeling algorithm extracts features from the object, determines a set of topics for a set of features, and generates a set of scores for the features, objects, and topics. An example of a topic modeling algorithms is LDA. In one or more embodiments, the objects in the topic modeling algorithm are text collections, the features are the words from within the text collections, and the scores include the topic vectors that relate topics to text collections. The topic vectors are stored in the repository and associated with the text collections.

In Step (208), additional text collections are received. In one or more embodiments, the additional text collections are received in response to user interaction. Examples of additional text collections include messages to chatbots, user generated articles, search strings, and browser histories, any of which are received from client devices by the server hosting the application. In one or more embodiments, the user interaction is after training the machine learning model. The user generated articles can be written by a user after using the application and can be provided to help other users utilize the application or answer frequently asked questions. The search strings are strings that can include search phrases and can include article titles. In one or more embodiments, the additional text collections are stored in the repository.

As an example, the application can be a search service that presents links in response to a search query and a browser history. A user searches for “homedepot charge” and does not click on any links in response to the query. The user then searches for “homedepot transaction” and clicks on a link for an article titled “missing transctions” (which was converted to lower case). The system generates a text collection in response to this user interaction in the form of a string that includes “homedepot charge homedepot transaction missing transactions”, which includes both search phrases and the article title.

In Step (210), additional topic vectors are generated without training the machine learning model on the additional text collections. In one or more embodiments, the machine learning system selects one of the additional text collections and passes the selected text collection as an input to the machine learning model. In response, the topic vector generator of the machine learning model outputs a topic vector for the selected text collection. The topic vector is generated by applying the previously trained machine learning model to the selected text collection. In one or more embodiments, the LDA algorithm is used and the topic vector is generated by calculating the most likely topic given the words in the text collections using a trained topic-word distribution matrix. If the selected text collection is part of the set of training documents, then the topic vector may be the row from the document topic matrix that corresponds to the selected text collection.

In Step (212), the list of topic vectors is updated with additional topic vectors. In one or more embodiments, the list of topic vectors stored in the repository is updated with additional topic vectors that were generated for the additional text collections. The additional topic vectors were generated by using the topic vector generator on the additional text collections before training the machine learning model on the additional text collections.

In Step (214), a first topic vector is received. In one or more embodiments, the first topic vector is generated by the topic identifier service and is received by the machine learning service. In one or more embodiments, the first topic vector is generated in response to interaction between the client device and the application. The topic identifier service generates an interaction string that identifies the interaction between the client device and the application, examples of which are described below. The topic identifier service passes the interaction string as part of a text collection to the machine learning model, which generates the first topic vector using the topic vector generator.

In one or more embodiments, the application is a chatbot. When the application is a chatbot, the interaction string is a message sent to the chatbot with the client device. For example, a client device logs into a website hosting the chatbot. The user enters a message into a text field of the website and clicks on a send button. The system receives the message and extracts the string from the message as the interaction string.

In one or more embodiments, the application is a website and the interaction string includes the titles of web pages selected with the client device during the current user session. The current user session includes a series of continuous search activities and click activities by the user that have not been interrupted by a break lasting at least a threshold amount of time. For example, a client device logs into a website and a clickstream is recorded of the user interaction. The clickstream includes the links that were clicked on by the user as well as the titles of the pages associated with the links that were clicked on by the user. The titles of the pages that were clicked on during the user session without a break lasting at least 30 minutes are appended to form the interaction string.

In Step (216), the first topic vector is matched to a topic vector from the list of topic vectors. In one or more embodiments, machine learning service compares the first topic vector to each topic vector of the list of topic vectors stored in the repository. The comparison can be performed by inputting the first topic vector and the list of topic vectors from the repository to the distance generator of the machine learning model. The distance generator generates a list of distances, which can be sorted from least to greatest distance to the first topic vector. Using the list of distances, the machine learning service can identify a predefined number (e.g., 1, 2, 5, 10, etc.) of topic vectors that are closest to the first topic vector as a collection of matched topic vectors. In one or more embodiments, the machine learning service identifies a matched topic vector as being a match to the first topic vector when the matched topic vector is the closest topic vector to the first topic vector having the least distance to the first topic vector. In one or more embodiments, unmatched topic vectors from the list of topics vectors can be identified by not being within a threshold distance to the first topic vector and may be removed from the collection of matched topic vectors.

In Step (218), links corresponding to the matched topic vectors are presented. In one or more embodiments, the links include a link to the text collection associated with the matched topic vector, with the link being presented in response to matching the first topic vector to the matched topic vector. The link is presented by the server transmitting the link to the client device, which displays the link.

In additional embodiments, instead of the links being presented, the content associated with the link is presented. For example, when the application is a chatbot, the content that is presented is the message from the chat bot to the user of the client device.

In Step (220), the corpus of training documents is updated to include training documents for additional text collections. In one or more embodiments, a set of text collections received since the machine learning model was last trained is processed to form a set training document that is included with the previously generated training documents within the repository to form an updated set of training documents.

In Step (222), the machine learning model is trained with the updated training documents and the list of topic vectors is updated. In one or more embodiments, the machine learning service retrains the machine learning model by applying the machine learning algorithm to each of the training documents, which include the training documents generated from the additional text collections. Additional and alternative embodiments may update the existing model by only training with the training documents generated from the additional text collections. The list of topic vectors for the text collections in the repository is updated with topic vectors generated using the updated machine learning model.

In Step (224), a second topic vector is received. In one or more embodiments, the second topic vector is generated by the topic identifier service from the same text collection used to generate the first topic vector in Step (214). The second topic vector is generated using the updated machine learning model.

In Step (226), the second topic vector is matched to a topic vector for a different text collection. In one or more embodiments, the matching process is similar to that described above in Step (216) with the exception that the updated machine learning model and the updated topic vectors for the text collections in the repository are used. With the updated machine learning model, the second topic vector has a value that is different from the value of the first topic vector. With the updated list of topic vectors based on the updated machine learning model, the group and ordering of matched topic vectors that are closest to the second topic vector are also different and can be associated with different text collections as compared to the matched topic vectors and text collections identified in Step (216).

In Step (228), a subsequent link is presented that is different from the previous link. In one or more embodiments, the previous link corresponds to the text collection matched with the first topic vector and the subsequent link corresponds to a different text collection that is matched with the second topic vector.

The process (200) can be repeatedly performed. Repetition of process (200) allows for the system to continuously provide better matches based on new text collections that are added to the system.

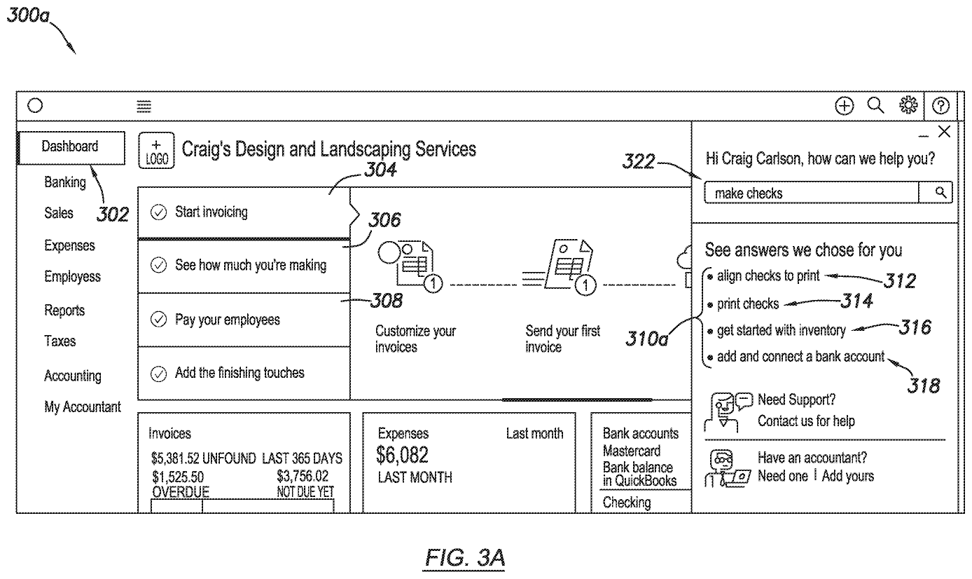

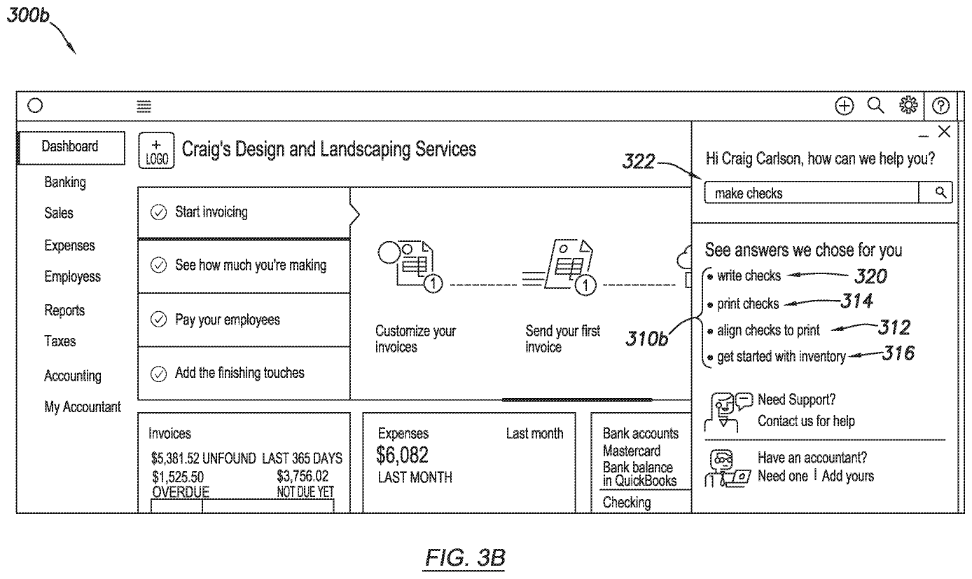

FIGS. 3A and 3B show an example in accordance with one or more embodiments of the present disclosure. The example of FIGS. 3A and 3B depicts a graphical user interface that is improved with topic vector generation and identification. The graphical user interface can be implemented on one or more components of the system (100) of FIG. 1. In one or more embodiments, one or more of the graphical user interface elements shown in FIGS. 3A and 3B may be omitted, repeated, combined, and/or altered as shown from FIGS. 3A and 3B. Accordingly, the scope of the present disclosure should not be considered limited to the specific arrangement shown in FIGS. 3A and 3B.

Referring to FIG. 3A, a web application hosted by a server is presented to a client device in a first browser session. In one or more embodiments, the web application is displayed within a web browser that executes on the client device. The client device displays the web application in a first graphical user interface (300a)

The web application displayed in the graphical user interface (300a) provides the user with functionality related to operating a business, which is exposed through a set of tabs that includes the dashboard tab (302). The dashboard (302) tab provides an overview and exposes functionality that is available through the web application with a set of interactive graphical elements that include the invoicing element (304), the accounting element (306), the employee payments element (308), etc.

The graphical user interface (300a) includes the search element (322). In one or more embodiments, interaction with the search element (322) allows the user of the client device to search for and locate articles that are hosted by the web application. Interaction with the search element (322) is performed by entering text and either pressing the enter key or selecting the button that is labeled with the magnifying glass. The search string (“make checks”) is transmitted to the application. The application uses the search string as an input to a topic vector generator, which generates a topic vector from the search string, which is referred to as a first topic vector. The application compares the first topic vector to a list of topic vectors that have already been generated for the articles hosted by the application.

The graphical user interface (300a) includes the links (310a), which are generated in response to the comparison of the first topic vector to the list of topic vectors. A first matched topic vector that is associated with the first link (312) is matched to the first topic vector generated from the search string in the search element (322). The first matched topic vector of the first link (312) is matched to the first topic vector by comparing the distances between the first topic vector and each of the topic vectors from the list of topic vectors and identifying that, out of the list of topic vectors, the first matched topic vector has the least distance and is closest to the first topic vector. The remaining links (314-318) in the set of links (310a) are associated with topic vectors that are the three next closest matches to the first topic vector, sorted by distance.

The first matched topic vector for the link (312) was generated using the machine learning model without training the machine learning model on the article associated with the link (312). The search related string from the search element (322) and the article for the link (312) are untrained text collections added to the repository after training the machine learning model on the training documents that were generated from a plurality of articles that include the articles associated with remaining links (314, 316, 318). Each of the topic vectors associated with the remaining links (314, 316, 318) were generated after the machine learning model was trained with the training documents. The training documents include documents for articles and includes documents for strings with search phrases and titles as described in FIGS. 1B and 1C.

Selection of the link (312) by the user causes the web browser on the client device to load the article that is associated with the link (312). Additionally, selection of the link (312) causes the application to store the search phrase from search element (322) and the title of the article from the first link (312) as a text collection in the repository. Selection of one of the remaining links (314, 316, 318) similarly causes the web browser to load the article that is associated with the selected link (314, 316, 318) and the application to generate text collections (strings with search phrases and article titles) that are stored in the repository. Multiple search phrases received within a threshold amount of time can be concatenated into a text collection. Duplicate text collections in the repository can be removed. Topic vectors can be generated for text collections as the text collections are added to the repository using the current machine learning model.

Referring to FIG. 3B, a second browser session is shown and the graphical user interface (300b) is presented. The search phrase in the search element (322) in the second browser session is the same as that for the first browser session described in FIG. 3A.

A second topic vector is generated from the search phrase in the search element (322) after retraining the machine learning model. The machine learning model was retrained after the first browser session and before the second browser session. The second topic vector is matched to a different article identified by the link (320).

The list of vectors are updated by applying the updated machine learning model to the text collections in the repository, which include additional text collections received after the machine learning model was previously trained. The update process to retrain the machine learning model occurs after the first browser session of FIG. 3A and before the second browser session of FIG. 3B. During the update process, the system retrains the machine learning model with additional text collections

With the updated topic vectors, the comparison of the list of topic vectors to the second topic vector yields a different result in which the second topic vector is matched to a second matched topic vector (associated with the link (320)), and the group and order of the four closest matched topic vectors to the second topic vector for the second browser session in FIG. 3B is different from the group and order of the four closest matched topic vectors to the first topic vector for the first browser session in FIG. 3A.

The links (310b) are updated from the links (310a) of FIG. 3A based on the group and order of the four closest matched topic vectors to the second topic vector. The links (310b) are updated from the links (310a) of FIG. 3A to include the link (320), to remove the link (316), and to reorder the links (320, 314, 312, 316). The links (310b) are different from the links (310a) of FIG. 3A because, even though the same search phrase was used, the machine learning model and the list of topic vectors that the second topic vector is compared to were updated.

Embodiments of the invention may be implemented on a computing system. Any combination of mobile, desktop, server, router, switch, embedded device, or other types of hardware may be used. For example, as shown in FIG. 4A, the computing system (400) may include one or more computer processors (402), non-persistent storage (404) (e.g., volatile memory, such as random access memory (RAM), cache memory), persistent storage (406) (e.g., a hard disk, an optical drive such as a compact disk (CD) drive or digital versatile disk (DVD) drive, a flash memory, etc.), a communication interface (412) (e.g., Bluetooth interface, infrared interface, network interface, optical interface, etc.), and numerous other elements and functionalities.

The computer processor(s) (402) may be an integrated circuit for processing instructions. For example, the computer processor(s) may be one or more cores or micro-cores of a processor. The computing system (400) may also include one or more input devices (410), such as a touchscreen, keyboard, mouse, microphone, touchpad, electronic pen, or any other type of input device.

The communication interface (412) may include an integrated circuit for connecting the computing system (400) to a network (not shown) (e.g., a local area network (LAN), a wide area network (WAN) such as the internet, mobile network, or any other type of network) and/or to another device, such as another computing device.

Further, the computing system (400) may include one or more output devices (408), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (402), non-persistent storage (404), and persistent storage (406). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the invention.

The computing system (400) in FIG. 7A may be connected to or be a part of a network. For example, as shown in FIG. 4B, the network (420) may include multiple nodes (e.g., node X (422), node Y (424)). Each node may correspond to a computing system, such as the computing system shown in FIG. 7A, or a group of nodes combined may correspond to the computing system shown in FIG. 7A. By way of an example, embodiments of the invention may be implemented on a node of a distributed system that is connected to other nodes. By way of another example, embodiments of the invention may be implemented on a distributed computing system having multiple nodes, where each portion of the invention may be located on a different node within the distributed computing system. Further, one or more elements of the aforementioned computing system (400) may be located at a remote location and connected to the other elements over a network.

Although not shown in FIG. 4B, the node may correspond to a blade in a server chassis that is connected to other nodes via a backplane. By way of another example, the node may correspond to a server in a data center. By way of another example, the node may correspond to a computer processor or micro-core of a computer processor with shared memory and/or resources.

The nodes (e.g., node X (422), node Y (424)) in the network (420) may be configured to provide services for a client device (426). For example, the nodes may be part of a cloud computing system. The nodes may include functionality to receive requests from the client device (426) and transmit responses to the client device (426). The client device (426) may be a computing system, such as the computing system shown in FIG. 7A. Further, the client device (426) may include and/or perform all or a portion of one or more embodiments of the invention.

The computing system or group of computing systems described in FIGS. 4A and 4B may include functionality to perform a variety of operations disclosed herein. For example, the computing system(s) may perform communication between processes on the same or different system. A variety of mechanisms, employing some form of active or passive communication, may facilitate the exchange of data between processes on the same device. Examples representative of these inter-process communications include, but are not limited to, the implementation of a file, a signal, a socket, a message queue, a pipeline, a semaphore, shared memory, message passing, and a memory-mapped file. Further details pertaining to a couple of these non-limiting examples are provided below.

Based on the client-server networking model, sockets may serve as interfaces or communication channel end-points enabling bidirectional data transfer between processes on the same device. Foremost, following the client-server networking model, a server process (e.g., a process that provides data) may create a first socket object. Next, the server process binds the first socket object, thereby associating the first socket object with a unique name and/or address. After creating and binding the first socket object, the server process then waits and listens for incoming connection requests from one or more client processes (e.g., processes that seek data). At this point, when a client process wishes to obtain data from a server process, the client process starts by creating a second socket object. The client process then proceeds to generate a connection request that includes at least the second socket object and the unique name and/or address associated with the first socket object. The client process then transmits the connection request to the server process. Depending on availability, the server process may accept the connection request, establishing a communication channel with the client process, or the server process, busy in handling other operations, may queue the connection request in a buffer until server process is ready. An established connection informs the client process that communications may commence. In response, the client process may generate a data request specifying the data that the client process wishes to obtain. The data request is subsequently transmitted to the server process. Upon receiving the data request, the server process analyzes the request and gathers the requested data. Finally, the server process then generates a reply including at least the requested data and transmits the reply to the client process. The data may be transferred, more commonly, as datagrams or a stream of characters (e.g., bytes).

Shared memory refers to the allocation of virtual memory space in order to substantiate a mechanism for which data may be communicated and/or accessed by multiple processes. In implementing shared memory, an initializing process first creates a shareable segment in persistent or non-persistent storage. Post creation, the initializing process then mounts the shareable segment, subsequently mapping the shareable segment into the address space associated with the initializing process. Following the mounting, the initializing process proceeds to identify and grant access permission to one or more authorized processes that may also write and read data to and from the shareable segment. Changes made to the data in the shareable segment by one process may immediately affect other processes, which are also linked to the shareable segment. Further, when one of the authorized processes accesses the shareable segment, the shareable segment maps to the address space of that authorized process. Often, only one authorized process may mount the shareable segment, other than the initializing process, at any given time.

Other techniques may be used to share data, such as the various data described in the present application, between processes without departing from the scope of the invention. The processes may be part of the same or different application and may execute on the same or different computing system.

Rather than or in addition to sharing data between processes, the computing system performing one or more embodiments of the invention may include functionality to receive data from a user. For example, in one or more embodiments, a user may submit data via a graphical user interface (GUI) on the user device. Data may be submitted via the graphical user interface by a user selecting one or more graphical user interface widgets or inserting text and other data into graphical user interface widgets using a touchpad, a keyboard, a mouse, or any other input device. In response to selecting a particular item, information regarding the particular item may be obtained from persistent or non-persistent storage by the computer processor. Upon selection of the item by the user, the contents of the obtained data regarding the particular item may be displayed on the user device in response to the user's selection.

By way of another example, a request to obtain data regarding the particular item may be sent to a server operatively connected to the user device through a network. For example, the user may select a uniform resource locator (URL) link within a web client of the user device, thereby initiating a Hypertext Transfer Protocol (HTTP) or other protocol request being sent to the network host associated with the URL. In response to the request, the server may extract the data regarding the particular selected item and send the data to the device that initiated the request. Once the user device has received the data regarding the particular item, the contents of the received data regarding the particular item may be displayed on the user device in response to the user's selection. Further to the above example, the data received from the server after selecting the URL link may provide a web page in Hyper Text Markup Language (HTML) that may be rendered by the web client and displayed on the user device.

Once data is obtained, such as by using techniques described above or from storage, the computing system, in performing one or more embodiments of the invention, may extract one or more data items from the obtained data. For example, the extraction may be performed as follows by the computing system in FIG. 4A. First, the organizing pattern (e.g., grammar, schema, layout) of the data is determined, which may be based on one or more of the following: position (e.g., bit or column position, Nth token in a data stream, etc.), attribute (where the attribute is associated with one or more values), or a hierarchical/tree structure (consisting of layers of nodes at different levels of detail-such as in nested packet headers or nested document sections). Then, the raw, unprocessed stream of data symbols is parsed, in the context of the organizing pattern, into a stream (or layered structure) of tokens (where each token may have an associated token “type”).

Next, extraction criteria are used to extract one or more data items from the token stream or structure, where the extraction criteria are processed according to the organizing pattern to extract one or more tokens (or nodes from a layered structure). For position-based data, the token(s) at the position(s) identified by the extraction criteria are extracted. For attribute/value-based data, the token(s) and/or node(s) associated with the attribute(s) satisfying the extraction criteria are extracted. For hierarchical/layered data, the token(s) associated with the node(s) matching the extraction criteria are extracted. The extraction criteria may be as simple as an identifier string or may be a query presented to a structured data repository (where the data repository may be organized according to a database schema or data format, such as XML).

The extracted data may be used for further processing by the computing system. For example, the computing system of FIG. 4A, while performing one or more embodiments of the invention, may perform data comparison. Data comparison may be used to compare two or more data values (e.g., A, B). For example, one or more embodiments may determine whether A>B, A=B, A !=B, A<B, etc. The comparison may be performed by submitting A, B, and an opcode specifying an operation related to the comparison into an arithmetic logic unit (ALU) (i.e., circuitry that performs arithmetic and/or bitwise logical operations on the two data values). The ALU outputs the numerical result of the operation and/or one or more status flags related to the numerical result. For example, the status flags may indicate whether the numerical result is a positive number, a negative number, zero, etc. By selecting the proper opcode and then reading the numerical results and/or status flags, the comparison may be executed. For example, in order to determine if A>B, B may be subtracted from A (i.e., A−B), and the status flags may be read to determine if the result is positive (i.e., if A>B, then A−B>0). In one or more embodiments, B may be considered a threshold, and A is deemed to satisfy the threshold if A=B or if A>B, as determined using the ALU. In one or more embodiments of the invention, A and B may be vectors, and comparing A with B requires comparing the first element of vector A with the first element of vector B, the second element of vector A with the second element of vector B, etc. In one or more embodiments, if A and B are strings, the binary values of the strings may be compared.

The computing system in FIG. 4A may implement and/or be connected to a data repository. For example, one type of data repository is a database. A database is a collection of information configured for ease of data retrieval, modification, re-organization, and deletion. Database Management System (DBMS) is a software application that provides an interface for users to define, create, query, update, or administer databases.

The user, or software application, may submit a statement or query into the DBMS. Then the DBMS interprets the statement. The statement may be a select statement to request information, update statement, create statement, delete statement, etc. Moreover, the statement may include parameters that specify data, or data container (database, table, record, column, view, etc.), identifier(s), conditions (comparison operators), functions (e.g. join, full join, count, average, etc.), sort (e.g. ascending, descending), or others. The DBMS may execute the statement. For example, the DBMS may access a memory buffer, a reference or index a file for read, write, deletion, or any combination thereof, for responding to the statement. The DBMS may load the data from persistent or non-persistent storage and perform computations to respond to the query. The DBMS may return the result(s) to the user or software application.

The computing system of FIG. 4A may include functionality to present raw and/or processed data, such as results of comparisons and other processing. For example, presenting data may be accomplished through various presenting methods. Specifically, data may be presented through a user interface provided by a computing device. The user interface may include a GUI that displays information on a display device, such as a computer monitor or a touchscreen on a handheld computer device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

For example, a GUI may first obtain a notification from a software application requesting that a particular data object be presented within the GUI. Next, the GUI may determine a data object type associated with the particular data object, e.g., by obtaining data from a data attribute within the data object that identifies the data object type. Then, the GUI may determine any rules designated for displaying that data object type, e.g., rules specified by a software framework for a data object class or according to any local parameters defined by the GUI for presenting that data object type. Finally, the GUI may obtain data values from the particular data object and render a visual representation of the data values within a display device according to the designated rules for that data object type.

Data may also be presented through various audio methods. In particular, data may be rendered into an audio format and presented as sound through one or more speakers operably connected to a computing device.

Data may also be presented to a user through haptic methods. For example, haptic methods may include vibrations or other physical signals generated by the computing system. For example, data may be presented to a user using a vibration generated by a handheld computer device with a predefined duration and intensity of the vibration to communicate the data.

The above description of functions presents only a few examples of functions performed by the computing system of FIG. 4A and the nodes and/or client device in FIG. 4B. Other functions may be performed using one or more embodiments of the invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method comprising:
training a machine learning model with a plurality of training documents generated from a plurality of text collections;
receiving, after generating a list of topic vectors for the plurality of text collections, an additional text collection;
generating an additional topic vector for the additional text collection without training the machine learning model on the additional text collection;
updating the list of topic vectors with a plurality of additional topic vectors that includes the additional topic vector;
receiving a first topic vector based on a first text collection generated in response to user interaction;
matching the first topic vector to the additional topic vector; and
presenting a link corresponding to the additional text collection in response to matching the first topic vector to the additional topic vector.

2. The method of claim 1 further comprising:
generating, before receiving the additional text collection, the list of topic vectors for the plurality of text collections by applying the machine learning model to the plurality of text collections,
wherein the plurality of text collections includes an article identified by the link,
wherein the first text collection includes a first string that includes a search phrase,
wherein the search phrase was entered by a user of the system,
wherein the plurality of text collections includes a second text collection that includes a second string,
wherein the second string includes the search phrase and an article title,
wherein the article title is from the article associated with the link, which has been clicked in response to receiving search results and has been clicked during a user session that includes a series of search activities and click activities by the user that were not interrupted by a break.

3. The method of claim 2, wherein the break is a timespan of at least 30 minutes.

4. The method of claim 1 further comprising:
updating the plurality of training documents to include the plurality of additional text collections to form an updated plurality of training documents.

5. The method of claim 4 further comprising:
training the machine learning model with the updated plurality of training documents to form an updated machine learning model.

6. The method of claim 5 further comprising:
updating the list of topic vectors using the updated machine learning model to form an updated list of topic vectors.

7. The method of claim 1 further comprising:
receiving a second topic vector based on the first text collection; and
matching the second topic vector to a second text collection that is different from the first text collection.

8. The method of claim 7 further comprising:
presenting a subsequent link to the second text collection,
wherein the subsequent link is different from the link corresponding to the additional text collection.

9. A system comprising:
a memory coupled to a processor;
a machine learning service that executes on the processor, uses the memory, and is configured for:
training a machine learning model with a plurality of training documents generated from a plurality of text collections;
receiving, after generating a list of topic vectors for the plurality of text collections, an additional text collection;
generating an additional topic vector for the additional text collection without training the machine learning model on the additional text collection;
updating the list of topic vectors with a plurality of additional topic vectors that includes the additional topic vector;
receiving a first topic vector based on a first text collection generated in response to user interaction;
matching the first topic vector to the additional topic vector; and
presenting a link corresponding to the additional text collection in response to matching the first topic vector to the additional topic vector.

10. The system of claim 9, wherein the set of instructions further cause the computer processor to perform the step of:
generating, before receiving the additional text collection, the list of topic vectors for the plurality of text collections by applying the machine learning model to the plurality of text collections,
wherein the plurality of text collections includes an article identified by the link,
wherein the first text collection includes a first string that includes a search phrase,
wherein the search phrase was entered by a user of the system,
wherein the plurality of text collections includes a second text collection that includes a second string,
wherein the second string includes the search phrase and an article title,
wherein the article title is from the article associated with the link, which has been clicked in response to receiving search results and has been clicked during a user session that includes a series of search activities and click activities by the user that were not interrupted by a break.

11. The system of claim 9, wherein the set of instructions further cause the computer processor to perform the step of:
updating the plurality of training documents to include the plurality of additional text collections to form an updated plurality of training documents.

12. The system of claim 11, wherein the set of instructions further cause the computer processor to perform the step of:
training the machine learning model with the updated plurality of training documents to form an updated machine learning model.

13. The system of claim 12, wherein the set of instructions further cause the computer processor to perform the step of:
updating the list of topic vectors using the updated machine learning model to form an updated list of topic vectors.

14. The system of claim 9, wherein the set of instructions further cause the computer processor to perform the step of:
receiving a second topic vector based on the first text collection; and
matching the second topic vector to a second text collection that is different from the first text collection.

15. The system of claim 14, wherein the set of instructions further cause the computer processor to perform the step of:
presenting a subsequent link to the second text collection,
wherein the subsequent link is different from the link corresponding to the additional text collection.

16. A non-transitory computer readable medium comprising computer readable program code for:
training a machine learning model with a plurality of training documents generated from a plurality of text collections;
receiving, after generating a list of topic vectors for the plurality of text collections, an additional text collection;
generating an additional topic vector for the additional text collection without training the machine learning model on the additional text collection;
updating the list of topic vectors with a plurality of additional topic vectors that includes the additional topic vector;
receiving a first topic vector based on a first text collection generated in response to user interaction;
matching the first topic vector to the additional topic vector; and
presenting a link corresponding to the additional text collection in response to matching the first topic vector to the additional topic vector.

17. The non-transitory computer readable medium of claim 16, further comprising computer readable program code for:
generating, before receiving the additional text collection, the list of topic vectors for the plurality of text collections by applying the machine learning model to the plurality of text collections,
wherein the plurality of text collections includes an article identified by the link,
wherein the first text collection includes a first string that includes a search phrase,
wherein the search phrase was entered by a user of the system,
wherein the plurality of text collections includes a second text collection that includes a second string,
wherein the second string includes the search phrase and an article title,
wherein the article title is from the article associated with the link, which has been clicked in response to receiving search results and has been clicked during a user session that includes a series of search activities and click activities by the user that were not interrupted by a break.

18. The non-transitory computer readable medium of claim 16, further comprising computer readable program code for:
updating the plurality of training documents to include the plurality of additional text collections to form an updated plurality of training documents.

19. The non-transitory computer readable medium of claim 18, further comprising computer readable program code for:
training the machine learning model with the updated plurality of training documents to form an updated machine learning model; and
updating the list of topic vectors using the updated machine learning model to form an updated list of topic vectors.

20. The non-transitory computer readable medium of claim 16, further comprising computer readable program code for:
receiving a second topic vector based on the first text collection;
matching the second topic vector to a second text collection that is different from the first text collection; and
presenting a subsequent link to the second text collection,
wherein the subsequent link is different from the link corresponding to the additional text collection.
